(19) United States
(12) Patent Application Publication
(10) Pub. No.: US 2007/0042822 A1
(43) Pub. Date: Feb. 22, 2007

(54) Combine with a rotary conveyor

(76) Inventors: Lutz Bischoff, Nunschweiler (DE); Klaus A. Braunhardt, Zweibrucken (DE)

Correspondence Address: DEERE & COMPANY, ONE JOHN DEERE PLACE, MOLINE, IL, 61265, US

(21) Appl. No.: 11/205,950

(22) Filed: Aug. 17, 2005

(51) Int. Cl. A01F 12/46

(52) U.S. Cl. 460/114

(57) ABSTRACT

A combine with straw walkers and a conveyor located above the straw walkers. The conveyor is provided with tines and a rotating body with a closed circle cylindrical envelope surface. The envelope surface of the rotating body has no remarkable recess or elevations. The tine guides each have a holder mounted to the rotating body and a guidance mounted to the holder. The guidance is pivotally mounted to the holder around a pivot axis extending parallel to the rotational axis of the rotating body. The guidance extends along the tine, surrounds the tine and has a length such that the tine retracts into the interior of the rotating body along a rotational angle of the rotating body of at least 450.

### FIELD OF THE INVENTION

The invention concerns a combine with straw walkers and a rotary conveyor arranged thereabove.

### BACKGROUND OF THE INVENTION

Various rotary conveyors have been proposed in the prior art that are mounted above the straw walkers of a combine, in order to grasp the product mat and divide it and, in this way, improve the separation effect. The straw is loosened longer and more intensively for thorough separation of the remaining grains. Heavier harvested product parts can escape through the created gaps by tearing of the harvested product carpet. Examples are disclosed in patents: DE 1 904 406 A, EP 0 862 848 A, EP 0 862 849 A, EP 0 862 850 A, EP 0 933 017 A, EP 1 050 206 A and FR 2 342 022 A. In all mentioned rotary conveyors, elements are provided that protrude outwardly beyond the outer surface of the rotating body, like tine guides or stripping elements. The tines also generally remain on the outside over the entire rotational angle of the rotary conveyor.

A drawback of these protruding elements is that straw or other plants, for example, the particularly problematical bindweed, can be trapped on them. They can be wound around the drum, so that a product blockage is produced.

A rotary conveyor arranged in a transverse conveyor screw of a combine is described in Patent GB 612 962 A, and is constructed from a rotatable, cylindrically circular rotating body with tines arranged eccentrically in it. The tines extend through tine guides arranged on the inside of the rotating body and pass through slits in the rotating body. Cavities are formed between the slits in the rotating body and the tine guides, allowing the harvested product to collect in the cavities.

U.S. Pat. No. 5,813,205 describes a guide assembly for tines of a transverse conveyor screw of a cutting mechanism. The guide assembly includes a first element rigidly mounted on the outside of the tube of the transverse conveyor screw. A sleeve is arranged between the inside of the first element and a shell. The sleeve is mounted to rotate around the rotational axis of the transverse conveyor screw. The sleeve has an axial opening, through which the eccentrically mounted tine extends outward. The tine disappears over a short rotational angle range in the interior of the tube of the transverse conveyor screw, but the outward protruding first elements result in the trapping of plants.

What is needed in the art is of a combine with a rotary conveyor arranged above the straw walker, that avoids the aforementioned drawbacks.

### SUMMARY OF THE INVENTION

One embodiment of the present invention includes a rotary conveyor containing a rotating body with at least one eccentrically mounted tine that is radially movable relative thereto. The subsequent description, however, describes several tines, because this is the normal case. The rotating body has a cylindrically circular outer surface without significant protrusions or recesses. The tines penetrate openings in the outer surface of the rotating body and can be mounted to move in tine guides on the outer surface, which are connected to the inside of the openings. The tine guides each include a holder that is fastened to the inside of the rotating body and lies against it and a guide mounted to pivot relative to the holder. The pivot axis of the guide extends parallel to the rotational axis of the rotating body. The guide has an axial opening through which the tine extends. The length of the guide is chosen such that the tine can be retracted over a larger rotational angle of the rotating body into its interior, for example, over 45° or even 60°.

In this manner, a situation is achieved in which the outside of the rotating body is fully free of any protruding or inward extending elements, at least over a rotational angle of 45°, on which plants or other material can be trapped. Since the holder of the tine guide lies against the inside of the rotating body, cavities on which material can collect or be trapped are also avoided on the inside of the opening in the rotating body for the tines.

The guide, for example, is spherical and arranged within a holder with the shape of a spherical shell. In another variant, the guide is a sleeve with lateral pins that are mounted to rotate on the holder, as described in U.S. Pat. No. 5,813,205 A.

In order to further reduce the hazard that the conveyed product lies around the rotary conveyor, a deflector sheet is positioned on the rotating body. By lowering the tines, it is possible to adjust a very small spacing between the deflector plate and the surface of the rotating body, so that the product being conveyed is sufficiently deflected. The deflector sheet can extend over the entire long side of the rotating body, or consist of strips that only keep the conveyed product away from the surface of the rotating body between the tines. If the deflector sheet is set very close to the drum, it can also tear off plant blades that hang up on the drum. This advantage becomes even more significant, as the gap between the deflector sheet and the rotating body is reduced.

If the deflector sheet is rigidly mounted, it can brake the rotary conveyor by any wound material. By measuring its drive moment, a warning signal is issued on surpassing of a threshold value, which warning indicates to the operator a jam and/or automatically stops the combine, so that the jam can be eliminated. As an alternative, the deflector sheet can be attached to a pivot such that it is tilted away by any product jam and activates a switch that trips the warning signal.

### BRIEF DESCRIPTION OF THE DRAWINGS

A practical example of the invention is further described and shown in the drawings. In the drawings:

FIG. 1 shows a harvesting machine with a rotary conveyor according to one embodiment of the present invention for distribution of the harvested product,:

FIG. 2 shows a longitudinal section through the center of the rotary conveyor of FIG. 1, with the tines mounted eccentrically in it; and

FIG. 3 shows a cross section through the rotary conveyor along line 3-3 viewed in the direction of the related arrows in FIG. 2.

### DESCRIPTION OF THE PREFERRED EMBODIMENT

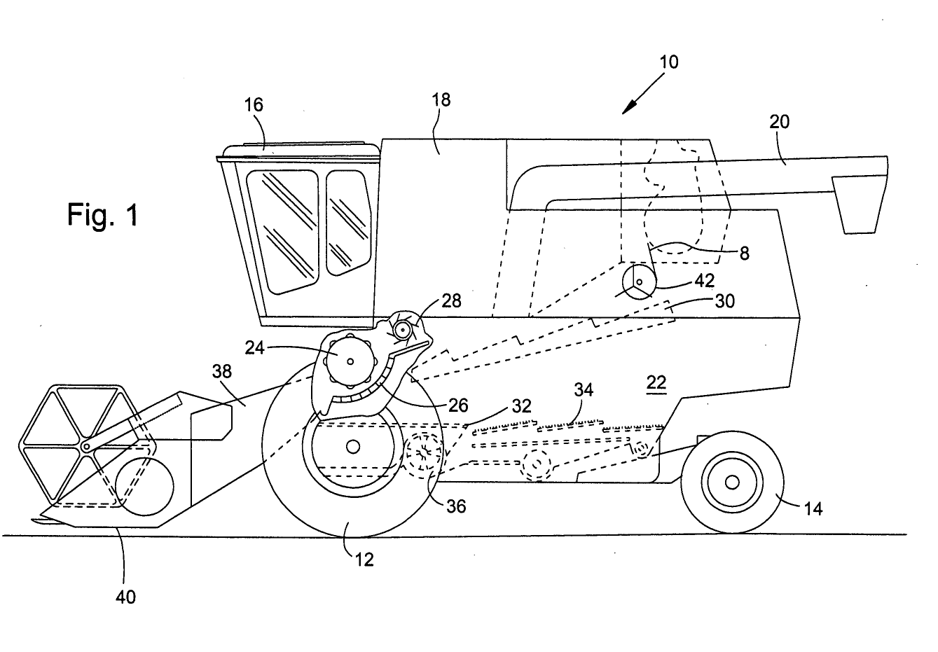

Referring now to the drawings, and more particularly to FIG. 1 there is shown a combine 10 with driven front wheels 12, steerable rear wheels 14 and a driver's cabin 16, from which combine 10 can be operated by a driver. A grain tank 18 is attached to the rear of driver's cabin 16 and delivers the product deposited in it outward through an emptying pipe 20. Grain tank 18 is mounted on a frame 22, in which the supplied product is broken down into its large and small components on its path over a threshing drum 24, a threshing basket 26 and a turning drum 28. Further separation of the harvested product is carried out on straw walkers 30, as well as a preparation base 32 and screens 34, wherein the threshed product fraction is finally conveyed into the grain tank 18. The large harvested product parts are deposited on the soil by way of straw walkers 30 and light components are also blown onto the soil by way of a blower 36 from screen 34. Product lying or standing on the ground is fed to threshing drum 24 by way of an oblique conveyor 38 after it is taken up from the ground by a harvested product recovery device 40.

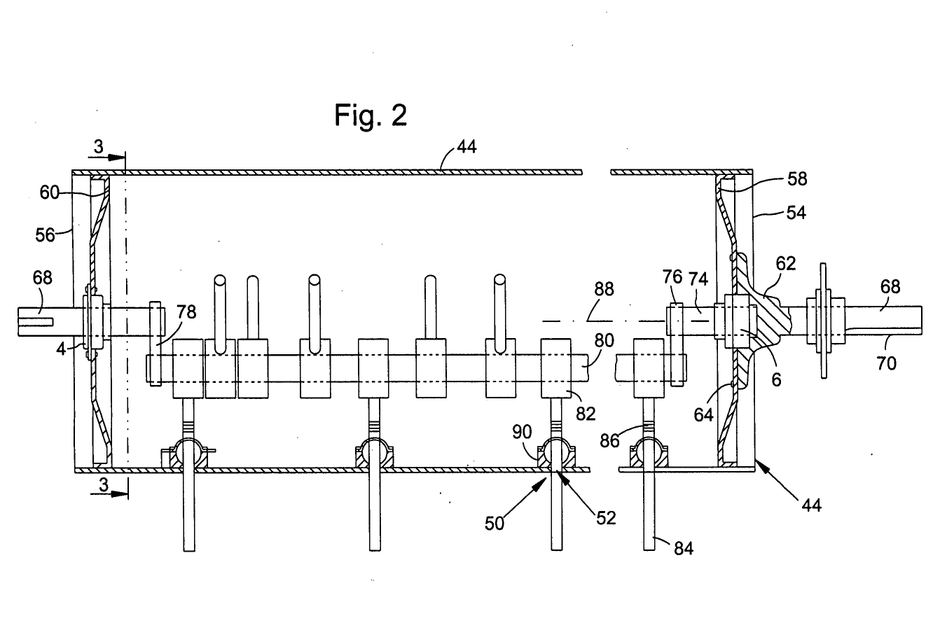

Now, additionally referring to FIG. 2, above straw walkers 30, a rotary conveyor 42 is provided that serves as an additional separator around an axis of rotation arranged transverse to the direction of travel, having a rotating body 44 and tines 84, as shown in FIG. 2, made of metal or plastic. A deflector sheet 8 is mounted on rotating body 44 and is mounted to pivot or it can be arranged to be fixed.

Rotation of rotary conveyor 42 occurs counterclockwise with a view toward FIG. 1, i.e., with undershot feed. For this purpose, drive devices (not shown) are provided, for example, a belt pulley connected to rotate in unison with a front wall of rotating body 44, which are driven by a motor.

The position of rotary conveyor 42 is preferably, but not necessarily, above straw walkers 30 in the region of their half length. This position can be changed vertically and horizontally by a corresponding guide. As an alternative, or additionally, rotary conveyor 42 could also be provided immediately downstream of turning drum 28.

The drive devices can be configured in a variety of ways and contain, for example, a speed variable and/or rotational direction reversible gear mechanism, with which the speed of rotary conveyor 42 can be changed and its direction of rotation reversed. In this manner, rotary conveyor 42 can be driven to feed both by overshoot and undershoot, wherein the position of tines 84 must be adjusted accordingly.

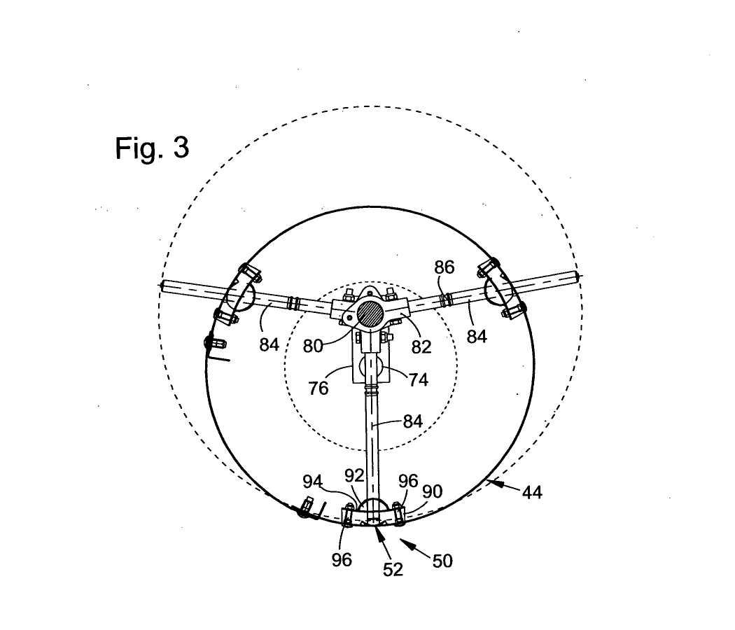

Now, additionally referring to FIG. 3, rotary conveyor 42 has a rotating body 44, whose outer surface is cylindrically circular without any recesses or elevations. In the depicted variant, eighteen plastic or metal tine guides 50 and openings 52 in rotating body 44 extend inward radially.

Front walls 54 and 56 of rotating body 44 are formed by disks 58 and 60, one of which is provided with a bearing flange 62 fastened by screws 64 to disk 58 at six hexagonally arranged sites. Disks 58 and 60 are spot welded to the inside of rotating body 44 and have cup like indentations on the side facing the interior of rotating body 44. Rotating body 44 is carried by shaft stubs 66 and 68. Shaft stub 66 is connected to bearing flange 62 and is provided with a keyway 70 for a gear, with which rotating body 44 can be rotated.

A bearing device, arranged eccentrically and parallel to the axis of rotation of rotating body 44, is situated in rotating body 44, containing two fixed shaft stubs 68 and 74, two support arms 76 and 78, and an axle 80. Clamps 82, which are made in two parts and pivotable, are attached to axle 80.

Tines 84 are formed as straight, solid and equally long rods with a circular cross section, in the depicted example, and with rupture sites 86, but can also be formed curved in the direction of rotation and need not, in principle, be solid. The feet of tines 84 are designed so that they fit into the corresponding recesses of clamps 82 and are secured thereto.

Tines 84 are arranged along axle 80 so that they are offset relative to each other by a fixed angle, for example, 120°, and extend through tine guides 50.

Axle 80 is rigidly connected to shaft stubs 74 and 68 by way of support arms 76 and 78. Shaft stub 74 is mounted to rotate in bearing flange 62 and shaft stub 68 is fixed outside of rotating body 44. By way of two roller bearings 4 and 6, a situation is achieved in which, during rotation of rotating body 44 in a plane perpendicular to longitudinal center axis 88, disks 58 and 60 rotate around fixed shaft stubs 68 and 74. Axle 80 retains its position and tines 84 are introduced and withdrawn during each revolution of rotating body 44 by way of tine guide 50. If a tine 84 is in the radially inward offset position, its free end is beneath the outer surface of rotating body 44.

The design of tine guides 50 can be deduced from FIGS. 2 and 3. They include a holder 90 fastened to the inside surface of rotating body 44, a guide 92 and a shell 94. Guide 92 is spherical and has a center opening through which a tine 84 extends. Holder 90 has a hemispherical bulge in which guide 92 is arranged. Shell 94 lies against the inside of holder 90, and also has a hemispherical bulge lying against guide 92. Shell 94 is joined to holder 90 by screws 96. Screws 96 can also extend through rotating body 44 and be flattened on its outside or arranged in recesses that are filled by their heads. Nuts then lie against shells 94. As an alternative, screws 96 extend through threaded holes of holder 90, which, in turn, is welded or glued to rotating body 44 or through nuts that are fastened, especially glued or welded, on the inside of rotating body 44.

Tine guides 50 are therefore directly connected to the inside of rotating body 44. Because of this, collection of plants and other material on the inside of openings 52 is prevented. Guide 92 is mounted to rotate in holder 90 and shell 94 around axis of rotation 88, so that, during one rotation of rotating body 44, it is moved with tines 84 around axis of rotation 88. The dimensions of tines 84 and guides 92 are chosen so that tines 84 are retracted into the interior of rotating body 44 over a rotational angle range of about 60°. Because of this, there is a significantly reduced hazard of plant parts and other material being entrained and causing a product jam.

According to FIG. 1, a deflector sheet 8 is positioned at rotating body 44 and oriented so that the conveyed product placed around rotating body 44 is stripped off during rotation of rotating body 44. Deflector sheet 8 is rigidly mounted. However, if material collects on rotating body 44, an increased torque is produced to drive rotating element 44. The torque is sensed by a sensor and, if it rises above a threshold value, a corresponding indication is furnished to the operator in driver's cabin 16 so that he can stop and clear the jam.

During use of rotary conveyor 42 in combine 10, tines 84 can be arranged so that they are situated in groups of three tines 84 above one straw walker 30, i.e., in a 5 straw walker machine, fifteen tines 84 are used, and in a 6 straw walker machine, eighteen tines, as shown in FIG. 2. The three tines 84 situated in front of front walls 54 and 56 of rotating body 44 in this example have a smaller spacing relative to each other than the remaining tines 84.

Having described the preferred embodiment, it will become apparent that various modifications can be made without departing from the scope of the invention as defined in the accompanying claims.

1. A combine, comprising:
a plurality of straw walkers; and
a rotary conveyor arranged above said plurality of straw walkers, said rotary conveyor including:
a plurality of tines;
a plurality of tine guides; and
a rotating body having a cylindrically circular, closed outer surface, said tines being mounted to rotate eccentrically in the interior of said rotating body relative to an axis of rotation, each of said tines movably extending radially through a respective one of said tine guides connected on an inside of an outer surface of said rotating body and through an opening in said outer surface of said rotating body, said outer surface of said rotating body being cylindrically circular and without significant recesses or elevations, said tine guides each having a holder mounted on said rotating body and a guide mounted so as to pivot in said holder around an axle running parallel to said axis of rotation of said rotating body, said tine guides extending in a longitudinal direction of said tine and encloses said tine, each said tine having a length such that said tine retracts into the interior of said rotating body over a rotational angle of said rotating body of at least 45°.

2. The combine of claim 1, further comprising:
a rigidly arranged deflector sheet running at a predetermined spacing relative to said rotating body; and
a system that monitors a torque to drive said rotating body and issues an alarm upon said torque surpassing a torque threshold value.
